(19) United States
(12) Patent Application Publication
(10) Pub. No.: US 2023/0155889 A1
(43) Pub. Date: May 18, 2023

(54) DEEP LEARNING METHOD FOR DISTRIBUTED MULTI-OBJECTIVE OPTIMIZATION, COMPUTER PROGRAM, AND APPARATUS THEREFOR

(71) Applicants: PUKYONG NATIONAL UNIVERSITY INDUSTRY-UNIVERSITY COOPERATION FOUNDATION, Busan (KR); KOREA UNIVERSITY RESEARCH AND BUSINESS FOUNDATION, Seoul (KR)

(72) Inventors: Hoon LEE, Busan (KR); Sang Hyun LEE, Seoul (KR)

(21) Appl. No.: 17/721,753

(22) Filed: Apr. 15, 2022

(30) Foreign Application Priority Data
Oct. 12, 2021 (KR) 10-2021-0135296

(51) Int. Cl. H04L 41/0823; G06N 3/04

(52) U.S. Cl. CPC H04L 41/0823; G06N 3/0454

(57) ABSTRACT

A deep learning method for distributed multi-objective optimization, computer program, and apparatus therefor. The method, performed by a computing device, for computing a local solution of a multi-objective optimization problem includes generating a first message for cooperation with at least one counterpart computing device based on a local observation and a priority weight, transmitting the first message to the counterpart computing device, receiving a second message from the counterpart computing device, and calculating the local solution for the computing device based on the local observation, the priority weight, and the second message.

### CROSS REFERENCE TO RELATED APPLICATIONS

This application is based on, and claims priority from, Korean Patent Application Number 10-2021-0135296, filed Oct. 12, 2021, the disclosure of which is incorporated by reference herein in its entirety.

### TECHNICAL FIELD

The present disclosure relates to a deep learning method for distributed multi-objective optimization, computer program, and apparatus therefor.

### BACKGROUND

The statements in this section merely provide background information related to the present disclosure and do not necessarily constitute prior art.

The Next-generation communication networks focus on the standardization of Machine-type Communication (MTC). The MTC system consists of a variety of terminals, and the types, preferences, and qualities of the communication services required by each terminal are different. The terminals share common radio channel resources since the MTC system is implemented as Ad hoc networks that do not have a centralized coordination mechanism.

To support the massive connectivity, a multi-objective resource allocation technique that simultaneously maximizes different local objectives of all terminals based on individual preferences of the terminals is necessary. The subject for calculating such a solution is a base station that serves the terminals, and the MTC system does not have a centralized coordination mechanism responsible for controlling all base stations. Therefore, a distributed multi-objective resource allocation technique is required. The conventional multi-objective resource allocation techniques are, however, based on centralized and iterative computation, which makes it impossible to derive real-time solutions.

### Non-Patent References

[1] D. Liu, C. Sun, C. Yang, and L. Hanzo, “Optimizing wireless systems using unsupervised and reinforced-unsupervised deep learning,” IEEE Netw., vol. 34, no. 4, pp. 270-277, July 2020.

[2] Q. Zhang and H. Li, “MOEA/D: A multiobjective evolutionary algorithm based on decomposition,” IEEE Trans. Evol. Comput., vol. 11, no. 6, pp. 712-731, August 2007.

[3] A. Trivedi, D. Srinivasan, K. Sanyal, and A. Ghosh, “A survey of multiobjective evolutionary algorithms based on decomposition,” IEEE Trans. Evol. Comput., vol. 21, no. 3, pp. 440-462, June 2017.

### SUMMARY

The present disclosure provides a method, a program, and apparatus for solving the multi-objective optimization problem in distributed and real-time.

According to at least one aspect, the present disclosure provides a method, performed by a computing device, for computing a local solution of a multi-objective optimization problem. The method includes generating a first message for cooperation with at least one counterpart computing device based on a local observation and a priority weight, transmitting the first message to the counterpart computing device, receiving a second message from the counterpart computing device, and calculating a local solution for the computing device based on the local observation, the priority weight, and the second message.

According to another aspect, the present disclosure provides a method, performed by a training device, for training one or more neural network modules by using an objective neural network and a dual neural network. The method includes acquiring a training data set which includes one or more local observations and one or more priority weights, training the dual neural network to output a dual variable for primal-dual optimization based on the priority weights and an output of the objective neural network, training the objective neural network to output a global objective of the neural network modules based on the priority weights and an output of the dual neural network, and training neural network modules to output a message for cooperation with each other and a local solution based on the training data set and the output of the dual neural network.

According to yet another aspect, the present disclosure provides a computing device for computing a local solution of a multi-objective optimization problem, including a processor, and a non-transitory memory storing at least one instruction executed by the processor. The processor is configured to generate a first message for cooperation with at least one counterpart computing device based on a local observation and a priority weight, transmit the first message to the counterpart computing device, receive a second message from the counterpart computing device, and calculate a local solution for the computing device based on the local observation, the priority weight, and the second message.

According to yet another aspect, the present disclosure provides a training device for training one or more neural network modules by using an objective neural network and a dual neural network, including a processor, and a non-transitory memory storing at least one instruction executed by the processor. The processor is configured to acquire a training data set which includes one or more local observations and one or more priority weights, train the dual neural network to output a dual variable for primal-dual optimization based on the priority weights and an output of the objective neural network, train the objective neural network to output a global objective of the neural network modules based on the priority weights and an output of the dual neural network, and train neural network modules to output a message for cooperation with each other and a local solution based on the training data set and the output of the dual neural network.

According to yet another aspect, a computer program stored in a computer-readable medium for executing the steps respectively included in the method performed by the computing device or the method performed by the training device.

According to an embodiment of the present disclosure, a neural network module can learn optimal local functions responsible for calculation and distributed coordination, respectively, based on deep learning.

According to an embodiment of the present disclosure, the trained neural network modules are installed in each base station such that each base station can calculate a local solution, which maximizes the performance of the wireless network, and message for cooperation with other base station in real-time.

### BRIEF DESCRIPTION OF THE DRAWINGS

FIG. 1 illustrates a network to which a method for distributed multi-objective optimization according to at least one exemplary embodiment of the present disclosure is applied.

FIGS. 2A, 2B and 2C illustrate a scalarization technique according to at least one exemplary embodiment of the present disclosure and conventional scalarization techniques.

FIG. 3 illustrates a geometrical interpretation of the Pareto-optimal boundary achieved by a cooperative-objective optimization approach in a 3-node network according to at least one exemplary embodiment of the present disclosure.

FIG. 4A illustrates a neural network module according to at least one exemplary embodiment of the present disclosure.

FIG. 4B illustrates a centralized training flow according to at least one exemplary embodiment of the present disclosure.

FIG. 4C illustrates a distributed implementation of neural network modules according to at least one exemplary embodiment of the present disclosure.

FIG. 5 illustrates training flow for messenger neural network according to at least one exemplary embodiment of the present disclosure.

FIG. 6 is a flowchart illustrating a method for training one or more neural network modules according to at least one exemplary embodiment of the present disclosure.

FIG. 7 is a flowchart illustrating a method for computing a local solution of a multi-objective optimization problem according to at least one exemplary embodiment of the present disclosure.

FIG. 8 is a block diagram illustrating a device for training one or more neural network modules according to at least one exemplary embodiment of the present disclosure.

FIG. 9 is a block diagram illustrating a device for computing a local solution of a multi-objective optimization problem according to at least one exemplary embodiment of the present disclosure.

### REFERENCE NUMERALS

10: network
100-1 to 100-3: node
110-1 to 110-3: terminal
400: neural network module
400-1 to 400-3: neural network module

### DETAILED DESCRIPTION

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, various terms such as first, second, A, B, (a), (b), etc., are used solely for the purpose of differentiating one component from others but not to imply or suggest the substances, the order or sequence of the components. Throughout this specification, when parts “include” or “comprise” a component, they are meant to further include other components, not excluding thereof unless there is a particular description contrary thereto. The terms such as “unit,” “module,” and the like refer to units for processing at least one function or operation, which may be implemented by hardware, software, or a combination thereof.

Hereinafter, as one exemplary embodiment of a distributed multi-objective optimization (MOO), distributed multi-objective resource allocation for resolving the competition among different nodes sharing limited wireless network resources will be described, but various embodiments are not limited thereto. The distributed MOO may be used to calculate a local solution of various multi-objective optimization problems.

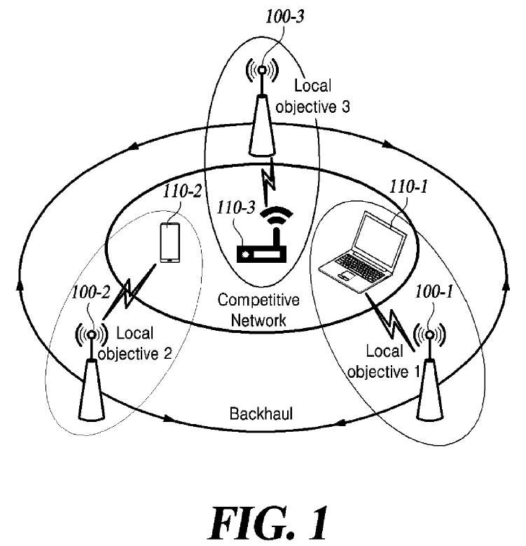

FIG. 1 illustrates a network to which a method for deep learning based distributed multi-objective optimization according to at least one exemplary embodiment of the present disclosure is applied.

Referring to FIG. 1, a network according to at least one exemplary embodiment of the present disclosure may include one or more nodes and one or more terminals. FIG. 1 illustrates that the network includes a first node 100-1, a second node 100-2, a third node 100-3, a first terminal 110-1, a second terminal 110-2 and a third terminal 110-3, but the network according to another exemplary embodiment of the present disclosure may include other numbers of nodes and/or terminals.

Each of the first node 100-1, the second node 100-2, and the third node 100-3 may be referred to as, in addition to “node,” “base station,” “wireless node,” “wireless point (AP),” “mobile edge-computing device (MEC device),” or other terms having equivalent technical meanings.

According to some exemplary embodiments, the first node 100-1, the second node 100-2, and the third node 100-3 may communicate with each other via a backhaul link.

Each of the first terminal 110-1, the second terminal 110-2 and the third terminal 110-3 may be referred to as in addition to “terminal,” “user equipment (UE),” “mobile station,” “wireless terminal,” “user device,” or other terms having equivalent technical meanings. The terminal according to various example embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-I audio layer-3 (MP3) player, a mobile medical device, a camera, and a wearable device, or the like, but is not limited thereto.

According to some exemplary embodiments, the first terminal 110-1, the second terminal 110-2 and the third terminal 110-3 may share common wireless resources in time and frequency domain. Thus, the corresponding system design may bear a competitive nature.

The wireless network management is generally described in a multi-objective optimization formulation, leading to simultaneous maximization of heterogeneous performance metrics that distinct nodes desire to elicit, e.g., quality-of-service (QoS) and data throughput metrics.

The i-th node makes an output decision of its own local solution xᵢ +from a networking strategy for maximizing local objective fᵢ(·) , where i is a natural number. Herein, the local solution may be a resource arrangement solution for the i-th node, but is not limited thereto. Local solutions collectively construct a global solution

$$x ≜ \left\{{x}_{i} : i ∈ V\right\} ,$$

where V is a group of nodes. The i-th node gathers states from the overall network to construct a successful decentralized policy along with individual observation aᵢ. This local observation may involve hands-on collection of the information from surrounding environments, e.g., channel state information (CSI). In some exemplary embodiments, the local observation may be referred to as “local data,” “local information,” “local state,” or other terms having equivalent technical meanings. The collected observation, that is global observation,

$$a ≜ \left\{{a}_{i} : i ∈ V\right\} ,$$

grasps stochastic properties impacting the performance. The local objective depends on the global information a and the associated global solution x, thus being represented in fᵢ(a,x). The multi-objective resource management obtains distributed solutions of all local objective functions in the MOO. This poses a fundamental optimization challenge in distributed wireless networks since an individual node can only access to partial information aᵢ, which is known insufficient for identifying the optimal solution.

Toward a sophisticated MOO solution of the distributed network, a coordinated mechanism for the optimization is necessary. A backhaul infrastructure interconnecting wireless nodes allows the exchange of observations and associated relevant statistics.

For tactical cooperation, i-th node may create message µᵢⱼ to forward to another j-th node through collected backhaul links ε where j is a natural number different from i. A set of outgoing messages

$${\hat{μ}}_{i} ≜ \{ {μ}_{i \text{} j} : ( i , j ) ∈ ε \}$$

transferred from i-th node may convey the quantized information about local observation aᵢ so that the internal content fits within the backhaul link capacity for the reduced signaling latency and overhead. Let Qᵢⱼ be the capacity of the backhaul link from i-th node to j-th node. The associated quantized message can be characterized by Qᵢⱼ different nonnegative integers as

$${μ}_{i j} ∈ {ℤ}_{{Q}_{i j}} ≜ \left\{0 , 1 , ... , {Q}_{i j} - 1\right\} .$$

receiving messages from the neighborhood, i-th node independently identifies its local solution Xᵢ with local observation aᵢ and incoming message

$${{μ}^{⌣}}_{i} ≜ \left\{{μ}_{j i} : ( i , j ) ∈ ε\right\} ,$$

In some exemplary embodiments, the message transferred to a counterpart node may be referred to as “outgoing message,” “first message,” or other terms having equivalent technical meanings. On the other hand, the message received form the counterpart node may be referred to as “incoming message,” “received messages,” “second message,” or other terms having equivalent technical meanings. Herein, the counterpart node of i-th node may be a neighborhood node interconnected with the i-th node via a backhaul link.

### Learning to Optimize Multiple Objectives

The distributed MOO invokes a joint optimization of solutions and message variables, more precisely, their computation strategies. This naturally leads to a functional optimization (refer to Non-patent reference [1]), which designs mapping rules from local observations to each of variables

$${\hat{μ}}_{i}$$

and xᵢ rather than determining directly. Such mapping rules are represented in functional forms as follows:

$$\begin{matrix}{\hat{μ}}_{i} = M {\text{}}_{i} \left({\text{a}}_{i}\right) , \\ {\text{x}}_{i} = X {\text{}}_{i} \left({\text{a}}_{i} , {{μ}^{⌣}}_{i}\right)\end{matrix}$$

Here, a computational operator

$${M}_{i} ( ⋅ )$$

elicits an input-output relationship of the message generation at i-th node. Furthermore, the local solution Xᵢ is made via a mapping

$${X}_{i} ( ⋅ )$$

of the received messages µᵢ and the local states aᵢ. These functions bring forth general computation procedures for arbitrarily given aᵢ instead of its certain fixed realization. To capture this, the functional optimization involves average performance metrics over inputs of mappings, i.e., the random network statistics

$$a ∈ A$$

lies in a probabilistic space

$$A$$

.

To this goal, a functional formalism of the distributed MOO task is induced as follows:

$$\begin{matrix}{max}_{\left\{M {\text{}}_{i} \left(⋅\right) , X {\text{}}_{i} \left(⋅\right) : ∀ i\right\}} \left({\text{a}}_{} \left[{f}_{1} \left(\text{a, x}\right)\right] , ⋯ , {\text{a}}_{} \left[{f}_{N} \left(\text{a,x}\right)\right]\right) \\ \text{subject to} {μ}_{i j} = {\left[M {\text{}}_{i} \left({\text{a}}_{i}\right)\right]}_{j} ∈ {ℤ}_{{Q}_{i j} ,} \left(i , j\right) ∈ E , \text{a} ∈ A\end{matrix}$$

where

$${\left[u\right]}_{j}$$

denotes the j-th element of vector u. The functional MOO in Equation 2 aims to obtain two functions

$${M}_{i} ( ⋅ )$$

and

$${X}_{i} ( ⋅ )$$

with the objective of maximizing average local objectives

$${E}_{a} \left[{f}_{i} ( a , x )\right] .$$

Note that this definition of objective functions facilitates to adapt to a random instance of local state.

The computation functions

$${M}_{i} \left(\cdot \right)$$

and

$${X}_{i} \left(\cdot \right)$$

in Equation 1 are thus replaced with individual Deep Neural Networks (DNNs)

$${M}_{{θ}_{i}} \left(\cdot \right)$$

and

$${M}_{{θ}_{i}} \left(\cdot \right)$$

, respectively, as follows:

$$\begin{matrix}{\hat{μ}}_{i} ≃ M {\text{}}_{{θ}_{i}} \left({\text{a}}_{i}\right) , \\ {\text{x}}_{i} ≃ X {\text{}}_{{ϑ}_{i}} \left({\text{a}}_{i} , {{μ}^{⌣}}_{i}\right)\end{matrix}$$

Here, θᵢ and

$${ϑ}_{i}$$

are trainable parameter sets dedicated to DNNs

$${M}_{{θ}_{4}} ( ⋅ )$$

and

$${M}_{{θ}_{i}} ( ⋅ )$$

,respectively.

### Cooperative Multi-objective Learning Formalism

A cooperative learning approach to the distributed MOO according to at least one exemplary embodiment focuses on identification of a set of a Pareto-optimal points, i.e., the Pareto boundary, simultaneously, instead of determination of a specific Pareto-optimum point where all local objectives achieve the maximal performance.

A typical wireless network operates under the environment of limited radio resources. For reliable access links, the network is subject to various heterogeneous QoS requirements which are normally characterized by local objectives competing with one another.

To mediate them, the priority among local objectives is reflected by a priority vector of nonnegative coefficients

$$\text{w} ≙ \left\{{w}_{i} i ∈ V\right\} .$$

In particular, a large value of priority weight indicates high connection reliability requested by the associated node, i.e., and also interpreted as the need for additional wireless resources. The set of all available priority vectors is referred to as W. An individual node determines the priority weight from a predefined rule according to its objective. Thus, priority weight may vary from time to time, and its realization is obtained only at i-th node.

Evolutionary MOO techniques can also provide the diversity of objective space boundary points. The set of the obtained solutions may not include the points where the priority vector touches on the boundary in the intended direction. Several reference vector-assisted algorithms may bring solutions with the desired priority weight. However, those algorithms run based on centralized computations which are generally undesirable in the wireless network management.

A MOO is reformulated into a cooperative-objective optimization (COO) so that multiple nodes optimize it cooperatively. Such a COO technique reveals that the original MOO can be equivalently transformed into a single-objective formulation with the guaranteed optimality even for a nonconvex local objective. The resulting COO can be separated into a set of subtasks, which are relevant to local objectives taken care of by individual nodes for their cooperative maximization.

The COO reformulation of Equation 2 via priority vector w leads to

$$\begin{matrix}{\text{max}}_{\left\{M {\text{}}_{i} \left(⋅\right) , X {\text{}}_{i} \left(⋅\right) : ∀ i\right\} , F} F \\ \text{subject to} \left(2 \text{b}\right) \text{and} {\text{a}}_{} \left[{f}_{i} \left(\text{a,x}\right)\right] \geq {w}_{i} F , i ∈ V\end{matrix}$$

Note that this COO obtains solution computation rules in Equation 1 together with the global objective value F. That is, the single global objective F is maximized, while i-th node meets a constraint

$${E}_{a} \left[{f}_{i} ( a , x )\right] \geq {w}_{i} F ,$$

which drives its local objective value to take at least wᵢ fraction of the global objective. Since local objectives are normally associated with distinct physical quantities, e.g., data rate and transmit power, these local objective constraints allow for the maximization of the global objective by comparison among individual objectives. Thus, this reformulated COO is a constrained optimization formulation subject to a number of local objective constraints.

A tractable approach for the constrained optimization is the Lagrange dual optimization that solves an equivalent unconstrained optimization penalized by weighted constraints with penalizing parameters, i.e., dual variables. Although a primal-dual approach can be applied straightforwardly to Equation 4 for a single priority weight, it is nontrivial to obtain simultaneous COO solutions for a large population of priority weight w.

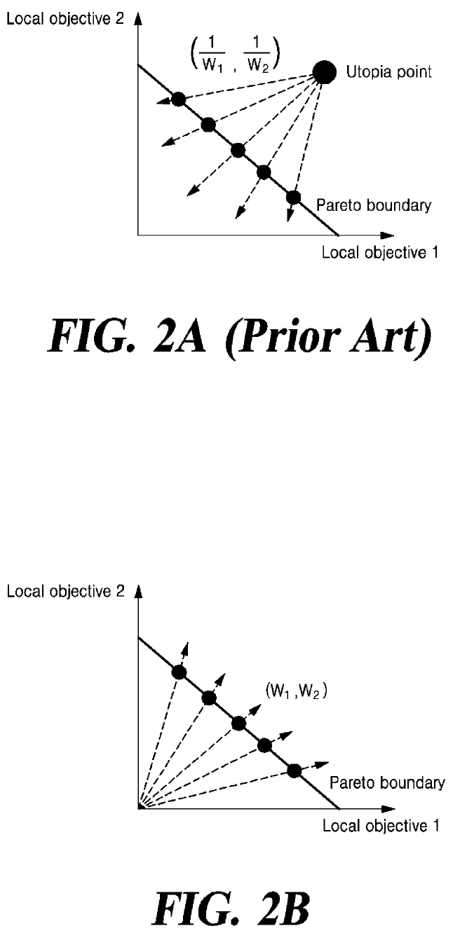

FIGS. 2A to 2C illustrate scalarization technique according to at least one exemplary embodiment of the present disclosure and conventional scalarization techniques.

The most popular among conventional scalarization techniques is the weighted Chebychev method employed in decomposition-based evolutionary algorithm. As shown in FIG. 2A, it minimizes a weighted measure of distances between the utopia point and the boundary points toward the direction

$$\left(\frac{1}{{w}_{1}} , \frac{1}{{w}_{2}}\right)$$

.

In contrast, the COO formulation technique according to at least one exemplary embodiment of the present disclosure addresses the distance of a Pareto boundary point from the origin, which exempts the prior knowledge of the utopia point. Referring to FIG. 2B, the global objective amounts to the length of priority vector (W_{1,}W₂). Thus, it corresponds to the Pareto-optimum in the direction of the priority vector.

As compared to the ε-constraint method in FIG. 2C that sets a lower bound along the direction of an individual local objective value in the multi-objective function output space, this simultaneously maximizes lower bounds of individual local objectives to find the objective space boundary point in the direction w. Thus, the adaptation of the boundary point according to the user preference is simplified.

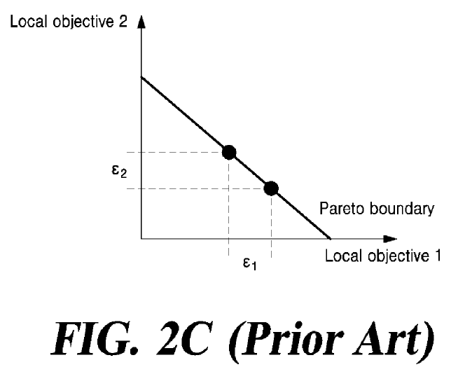

FIG. 3 illustrates a geometrical interpretation of the Pareto-optimal boundary achieved by a cooperative-objective optimization approach in a 3-node network according to at least one exemplary embodiment of the present disclosure.

A 3-element priority vector (W_{1,} W_{2,} W₃)reflects the overall objective associated with the services provided in the network. The cooperative maximization of the global objective by 3 nodes is inspired that individual nodes ensure their maximum incentives, i.e., local objectives. An important observation is that the global objective value F, which corresponds to an intersection point of the priority vector and the Pareto-optimal boundary, varies with the direction of w.

Inspired by decomposition-based evolutionary principles in Non-patent reference [2] and [3], it is desired to address multiple instances of the COO formulation in Equation 4 associated with distinct configurations of w at the same time.

The corresponding local solutions Xᵢ as well as quantized messages

$${\hat{μ}}_{i} ≙ \left\{{μ}_{i j} : ( i , j ) ∈ ε\right\}$$

depend on w along with local observations.

To develop a universal MOO learning strategy, it is important to incorporate w as an additional input feature to functions that produce individual variables. To this end, additional mapping

$$F = F ( w )$$

is introduced to relate the global objective value F with the priority weight input w. Thus, it is natural to incorporate local preference wi in the operators in Equation 1 to take this feature into account as

Based on the learning to optimize principle, these computational functional units can be successfully modeled by DNNs as follows:

$$\begin{matrix}F = F \left(\text{w}\right) ≃ F {\text{}}_{φ} \left(\text{w}\right) , & \left(5 \text{a}\right) \\ {\hat{μ}}_{i} = M {\text{}}_{i} \left({\text{a}}_{i} , {w}_{i}\right) ≃ M {\text{}}_{{θ}_{i}} \left({\text{a}}_{i} , {w}_{i}\right) , & \left(5 \text{b}\right) \\ {\text{x}}_{i} = {X}_{i} \left({\text{a}}_{i} , {{μ}^{⌣}}_{i} , {w}_{i}\right) ≃ {X}_{{ϑ}_{i}} \left({\text{a}}_{i} , {{μ}^{⌣}}_{i} , {w}_{i}\right) . & \left(5 \text{c}\right)\end{matrix}$$

DNN

$${F}_{φ} \left(\cdot \right)$$

with learnable parameter set φ in (5a) is referred to as objective DNN. It accounts for the location of the global objective F in the objective space boundary for arbitrary given priority vector w.

Messenger DNN

with parameter set θi in (5b) calculates outgoing message µᵢ broadcast from i-th node by encapsulating its local statistics, i.e., observation vector aᵢ and priority weight wᵢ.

A local solution Xᵢ is determined via optimizer DNN that uses the corresponding trainable parameters Vᵢ along with local information and received messages µᵢ.

These component DNN units contained in a DNN tile universally handle the COO instances associated with a diverse range of the priority weights and the local states. To this end, these DNN units are coordinated to parameterize a primal-dual algorithm that solves a constrained optimization problem. Thus, all computations involved in the primal-dual algorithm are conducted by DNN units. Although this approach has been validated in a number of SOO applications, a novel training strategy dedicated to an MOO task that finds multiple Pareto-optimal points is necessary.

For a parameterized MOO solution, machine-learning-based surrogate modeling has been recently studied under evolutionary MOO frameworks. A surrogate model is desired to output intermediate feature variables of existing evolutional algorithms. This turns out to be efficient in handling an optimization problem, in particular, in case that it has the data only but does not have explicit formulations. According to at least one exemplary embodiment of the present disclosure, the surrogate modeling may be applied in Equation 5 to introduce additional flexibility in DNN learning structures by characterizing end-to-end computations of the MOO solution inference and joint design of component units.

The parameterized functions in Equation 5 adapt to the network states in terms of global observation a and priority vector w. A functional optimization framework requires an average performance measure over all available observations and all feasible choices of the priority vector. Thus, the resulting global objective

becomes a scalar maximization target of the COO formulation. The corresponding constraint on the average local objective is imposed in an inequality form, i.e.,

The average local objective is expressed as follows:

$${\tilde{f}}_{i} \left(θ , \text{w}\right) = {E}_{\text{a}} \left[{f}_{i} \left(\text{a,} \left\{{X}_{{ϑ}_{j}} \left({\text{a}}_{j} , {\hat{μ}}_{j} , {w}_{j}\right) : \left(i , j\right) ∈ E\right\}\right)\right]$$

Here,

denotesthe set of trainable parameters of the messenger DNN and the optimizer DNN.

Combining these with Equation 5, the distributed COO of Equation 4 is formulated in a learning model as follows:

$$\begin{matrix}{max}_{θ , φ} \tilde{F} \left(φ\right) & \left(7 \text{a}\right) \\ \text{subject} \text{to} {\tilde{f}}_{i} \left(θ , \text{w}\right) \geq {w}_{i} {F}_{φ} \left(\text{w}\right) , i ∈ V , \text{w} ∈ W , & \left(7 \text{b}\right) \\ {μ}_{i j} = \left[M {\text{}}_{{θ}_{i}} {\left({\text{a}}_{i} , {w}_{i}\right)}_{j} ∈ {ℤ}_{{Q}_{i j}} , \left(i , j\right) ∈ E\right] , & \text{} \\ \text{a} ∈ A , \text{w} ∈ W . & \left(7 \text{c}\right)\end{matrix}$$

The distributed COO in Equation 7 tackles all instances of Equation 4 with distinct priority weights

$$\text{w} ∈ W .$$

Furthermore, it can be viewed as a training problem of DNN parameters θ and φ. However, it remains still quite challenging to handle Equation 4 by means of conventional (unconstrained) training algorithms, e.g., stochastic gradient descent (SGD) algorithms, for the failure to direct consideration of nontrivial constraints such as (7b) and (7c) in Equation 7. The type of the constraint differs according to the way of handling the observation vector a. For example, the constraint in (7b), regulating the behavior of the optimizer DNN

$${X}_{{θ}_{i}} \left(\cdot \right)$$

in (5c) of Equation 5, is an average constraint that defines an inequality about average values taken over the distribution of a. On the other hand, the constraint in (7c) is satisfied for a specific realization of a, thereby imposing an instantaneous constraint about messenger DNN

$${M}_{{θ}_{i}} \left(\cdot \right)$$

in (5b) of Equation 5. Therefore, heterogeneous constraint types request distinct training strategies for optimizer DNN and messenger DNN.

### Learning Strategy for MOO Solution

A constrained learning approach focuses on the average local objective constraint for the distributed COO in Equation 4. A constrained optimization problem is generally approached via Lagrange dual method. An unconstrained dual formulation, called by the Lagrangian function, is constructed so that the resulting solution is equivalent to one for the original constrained counterpart. The Lagrangian of (4) is defined as

$$L \left(θ , φ , λ\right)$$

with respect to the collection of nonnegative dual variables associated with the constraint in (7b) of Equation 7 for i and w,

$$λ ≙ \left\{{λ}_{i , \text{w}} : i ∈ V , w ∈ W\right\} .$$

It is expressed as follows:

$$L \left(θ , φ , \text{λ}\right) = \tilde{F} \left(φ\right) + {\sum }_{\text{w} ∈ W} {\sum }_{i ∈ V} {\text{λ}}_{i , \text{w}} \left({\tilde{f}}_{i} \left(θ , \text{w}\right) - {w}_{i} F {\text{}}_{φ} \left(\text{w}\right)\right)$$

The solution of the constrained formulation is alternatively obtained by addressing a Lagrange dual optimization problem given by

$${min}_{λ} {max}_{θ , φ} L \left(θ , φ , λ\right) .$$

This indicates that, along with the DNN parameters, the dual variables are optimized for the minimization of the Lagrangian, involving the identification of a computational rule for λ. The functional optimization approach (refer to Non-patent reference [1]) can be extended to determine a mapping function of the dual variable. Dual variable λᵢ,_{w} is viewed as a function of the priority vector w that lies in a vector space

$$W .$$

Such a computation rule is constructed by a dual DNN

$${N}_{ψ} \left(\cdot \right)$$

as follows:

$${\text{λ}}_{i , \text{w}} = {\left[N {\text{}}_{ψ} \left(\text{w}\right)\right]}_{i}$$

It is noticed that a nonnegative activation function, e.g., rectified linear unit (ReLU) or softplus, is used at the output layer of the dual DNN

$${N}_{ψ} \left(\cdot \right)$$

to produce nonnegative dual variables for complementary slackness.

Substituting Equation 9 with Equation 8 modifies the Lagrangian

$$L \left(θ , φ , λ\right)$$

as a function of trainable parameters of the messenger-optimizer DNN θthe objective DNN φ, and the dual DNN Ψ. The resulting function is decomposed into the sum of two subfunctions given by

$$L ( θ , φ , ψ ) = G ( θ , ψ ) + H ( φ , ψ )$$

with Equation 10.

$$\begin{matrix}G \left(θ , ψ\right) ≜ {\sum }_{w ∈ W} {N}_{ψ} {\left(\text{w}\right)}^{T} \text{} \tilde{\text{f}} \left(θ , \text{w}\right) , \\ H \left(φ , ψ\right) ≜ {\sum }_{\text{w} ∈ W} \left(\frac{1}{\left|W\right|} - {N}_{ψ} {\left(\text{w}\right)}^{T} \text{} \text{w}\right) ⋅ {F}_{φ} \left(\text{w}\right)\end{matrix}$$

Here,

$$\left|W\right|$$

is the number of all priority weight candidates of the network and

$$\tilde{\text{f}} \left(θ , \text{w}\right) ≙ \left\{{\tilde{f}}_{I} \left(θ , \text{w}\right) : i ∈ V\right\} .$$

The corresponding dual problem is formulated as follows:

$${min}_{ψ} {max}_{θ , φ} L \left(θ , φ , ψ\right)$$

The dual optimization in Equation 11 is solved by the primal-dual method. It alternates the updates of primal variables and dual variables. The primal DNN parameters θ and φare updated to maximize the Lagrangian, which, equivalently, back-propagates

$$L \left(θ , φ , ψ\right)$$

based on the standard gradient descent algorithm. Subsequently, the dual update for is conducted to minimize the Lagrangian. The alternated update strategy is expressed as follows:

$$\begin{matrix}\text{Primal} \text{update:} \left\{\begin{matrix}θ ← θ + η {∇}_{0} G \left(θ , φ , ψ\right) \\ φ ← φ + η {∇}_{φ} H \left(θ , φ , ψ\right)\end{matrix}\right) \\ \text{Dual} \text{update:} ψ ← ψ - η {∇}_{ψ} L \left(θ , φ , ψ\right)\end{matrix}$$

Here, η is a nonnegative parameter that adjusts the learning rate and ∇ᵤ stands for the gradient operator with respect to u. The mini-batch SGD variants, such as the Adam algorithm, are applied to realize primal-dual learning principles, which enable constrained DNN training tasks.

### Training of DNN Tiles

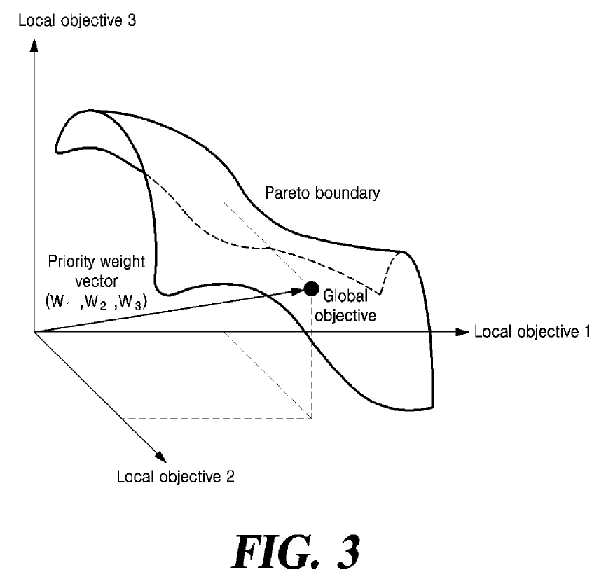

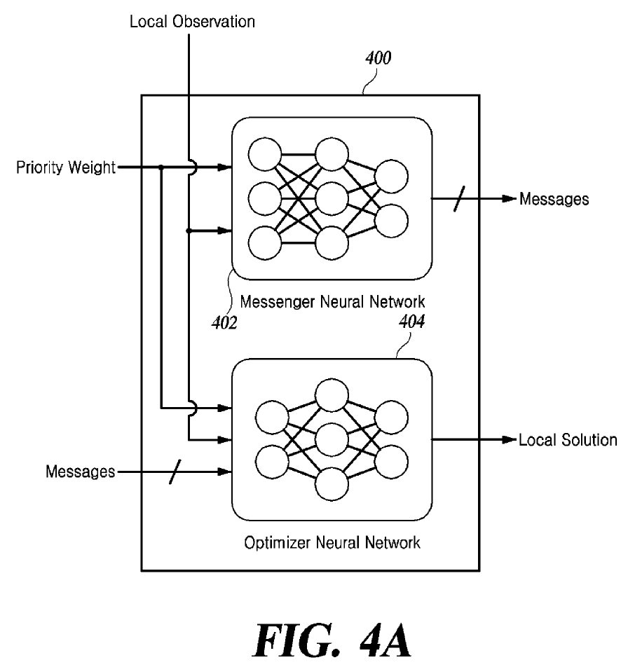

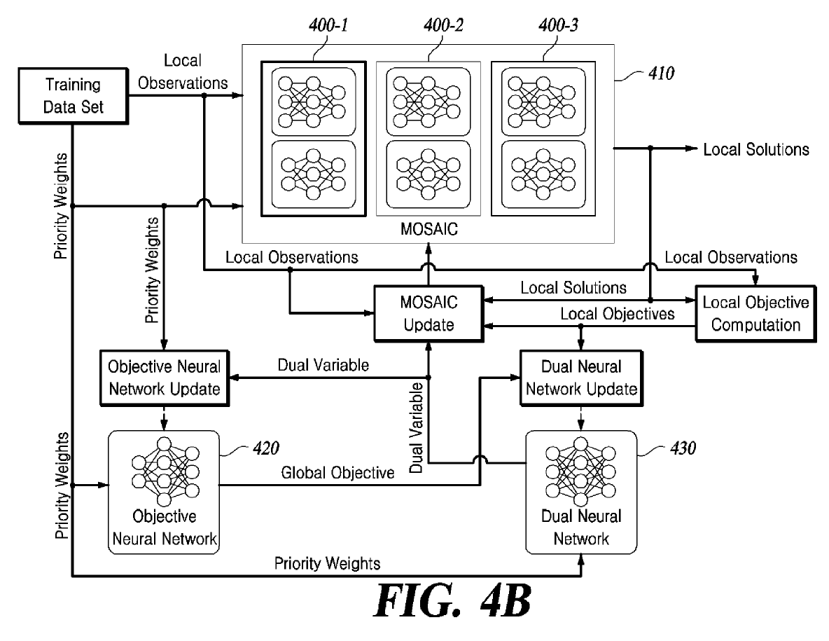

FIG. 4A illustrates a neural network module according to at least one exemplary embodiment of the present disclosure.

FIG. 4B illustrates a centralized training flow according to at least one exemplary embodiment of the present disclosure.

FIG. 4C illustrates a distributed implementation of neural network modules according to at least one exemplary embodiment of the present disclosure.

The need for a distributed multi-objective resource management is motivation of this invention that calculates an AI-aided COO solution with simple learning rules.

A node is equipped with a neural network module 400, i.e., a suite of local neural network units. As shown in FIG. 4A, the neural network module 400 may include all or some of a messenger neural network 402, which is pre-trained to generate message for cooperation with one or more other nodes, and an optimizer neural network 404, which is pre-trained to calculate a local solution in an individual node. The messenger neural network 402 and the optimizer neural network 404 may be implemented as DNN, but are not limited thereto.

The messenger neural network 402 and the optimizer neural network 404 for i-th node may correspond to messenger DNN

$$M {\text{}}_{{θ}_{i}} \left(⋅\right)$$

and optimizer DNN

$$X {\text{}}_{{ϑ}_{i}} \left(⋅\right)$$

in Equation 5, respectively.

A learning mechanism according to at least one exemplary embodiment of the present disclosure relies on the interplay of a pair of additional neural network units incorporated in the neural network module 400. This neural network unit pair conducts local calculations involved in the distributed MOO and obtaining low-dimensional representations of messages, respectively, for the universal cooperation among neural network module 400 in heterogeneous objective MOO tasks.

The training algorithm according to at least one exemplary embodiment of the present disclosure is distinct from conventional learning techniques. The global objective value takes possibly a non-physical quantity so that it can compare among local objective values associated with different physical interpretations. Each NN module 400 may produce a meta-output that is handled universally to obtain the final solution with heterogeneous local objectives. This naturally calls for additional AI units that evaluate the actual objective function dedicated to a specific MOO problem. Therefore, the overall training strategy enables to evaluate local solutions which achieve the Pareto-optimal tradeoff among heterogeneous utilities for any priority weight configuration. Consequently, the AI-based formalism accommodates a distributed implementation that establishes multiple Pareto-boundary points for arbitrary networking setup.

As shown in FIG. 4A, the messenger neural network 402 may convert the local observation and the priority weight into outgoing messages forwarded to neighboring nodes. The optimizer neural network may make a local decision using incoming messages transferred from the neighborhood. As a result, the operations of neural network module 400 at individual nodes may proceed independently only with locally available knowledge.

Referring FIG. 4B, two auxiliary AI units, i.e., an objective neural network 420 and a dual neural network 430 may be used for training one or more neural network modules 400-1, 400-2 and 400-3. The objective neural network 420 and the dual neural network 430 may correspond to objective DNN

$${F}_{φ} \left(⋅\right)$$

in Equation 5 and dual DNN

$${N}_{ψ} \left(⋅\right)$$

in Equation 9, respectively. The objective neural network 420 and the dual neural network 430 may supervise the update of the one or more neural network modules 400-1, 400-2 and 400-3 to ensure the constraint in (7b) of Equation 7 so that the i-th local objective occupies wᵢ fraction of the global objective.

The primal-dual update algorithms in Equation 12 are realized by a set of distinct neural networks dedicated to relevant parameters. The interplay among the one or more neural network modules 400-1, 400-2 and 400-3, the objective neural network 420 and the dual neural network 430 consolidates a novel training procedure as summarized in Table 1.

TABLE 1

Initialize θ, φ, ψ.
repeat
Primal update: $θ ← θ + η {∇}_{θ} G \left(θ , ψ\right)$ $φ ← φ + η {∇}_{φ} H \left(φ , ψ\right)$

Dual update: $ψ ← ψ - η {∇}_{ψ} J \left(θ , φ , ψ\right)$

until convergence

The messenger-optimizer parameter θ of is evolved so that all local objectives f̅(θ, w) collectively achieve the maximum of G(θ,ψ) in Equation 10. Furthermore, the dual neural network 430, i.e., dual DNN N_{ψ}(·) in Equation 9, adjusts the contribution of individual objectives to reach a Pareto-boundary point in the direction of the priority vector. To this end, it jointly controls the feasibility of multiple individual constraints (7b) in Equation 7 associated with local objectives by minimizing the feasibility measure J(θ,φ,ψ) defined as follows:

$$J \left(θ , φ , ψ\right) ≜ {\sum }_{\text{w} ∈ W} {N}_{ψ} {\left(\text{w}\right)}^{T} \left(\tilde{\text{f}} \left(θ , \text{w}\right) - \text{w} ⋅ {F}_{φ} \left(\text{w}\right)\right)$$

Here, J(θ,φ,ψ) becomes zero at the optimal condition according to the complementary slackness. The nonnegativity of the dual DNN output regulates an infeasible local constraint f̅ᵢ(θ, w) < wᵢF_{φ}(w) in the Lagrangian by increasing the corresponding dual variable [N_{Ψ}(w)]ᵢ that penalizes the constraint. This subsequently affects the primal update of the objective parameter φ to increase the primal objective ℌ(φ,ψ) in Equation 10, which is, in fact, the weighted average of global objectives F_{φ}(w) with respect to various directions of w. Meanwhile, the dual neural network 430 may control the sign of the gradient updates. If its output takes a large value or the corresponding local objective constraint (7b) in Equation 7 become infeasible, the neural network associated with ℌ(φ,ψ) may reduce the global objective value, thereby automatically relaxing the bound in the local inequality constraint. However, upon the satisfaction of all constraints that nullify λ_{i,w}, ℌ(φ,ψ) updates to improve F_{φ}(w).

The training computations of the overall units can be combined together. A network cloud may jointly train neural network modules 400-1, 400-2 and 400-3 constituting the learning units 410 and two auxiliary neural networks, i.e., the objective neural network 420 and the dual neural network 430, by means of powerful computation resources. The training data set is prepared with collections of local observations and priority weights. The mini-batch training policy runs according to the primal-dual update rules in Table 1. The training algorithm updates the parameters such that local solutions cooperatively maximize the global objective under constraints associated with local objectives. To realize it, the back propagation maximizes the Lagrangian with respect to primal variables θ and φ, while the SGD algorithm minimizes dual variables. The objective neural network 420 and the dual neural network 430 may evaluate the global objective and the dual variables for arbitrarily sampled priorities, respectively, so that the global objective value is located on the objective space boundary and each of the one or more neural network modules 400-1, 400-2 and 400-3 yields the maximized local objective. The estimated objectives may update the dual neural network 430 so that the resulting dual variables determine the feasibility of the associated constraints. Thus, the objective neural network 420 improves the global objective among feasible solutions, i.e., in the direction of the priority vector. Also, the one or more neural network modules 400-1, 400-2 and 400-3 may compute the corresponding feasible local solutions.

In some exemplary embodiments of the present disclosure, the pair of the objective neural network 420 and the dual neural network 430 may depend only on the priority vector w. Thus, the objective neural network 420 and dual neural network 430 may be activated only in training all distributed learning units 410, i.e., the overall set of one or more neural network modules 400-1, 400-2 and 400-3, since they do not affect the forward pass computation of the one or more neural network modules 400-1, 400-2 and 400-3. The trained learning units 410 suffices to calculate the primal solution set via the real-time inference without knowledge of the outputs calculated by the objective neural network 420 and the dual neural network 430. Once trained, the objective neural network 420 and the dual neural network 430 depicted in FIG. 4A are removed, which becomes a pure set of interconnected the one or more neural network modules 400-1, 400-2 and 400-3, each installed in a wireless node for the deployment. The resulting distributed implementation reduces a network arrangement of the one or more neural network modules 400-1, 400-2 and 400-3 as described in FIG. 4C.

Referring FIGS. 4A to 4C, the messenger neural network 402 in each of the neural network modules 400-1, 400-2 and 400-3 may take the local observation as the input to produce messages. As shown in FIG. 4, The resulting messages are distinct according to their destinations, and each outgoing message is transferred to the dedicated neural network module interconnected via an internode link. The incoming messages collected at the neural network modules 400-1, 400-2 and 400-3 are fed to the built-in optimizer neural network 404 to calculate its independent local solution. The structures of messenger neural network 402 and optimizer neural network 404 can be trained either uniformly or distinctly over the neural network modules 400-1, 400-2 and 400-3 according to the network arrangement of the neural network modules 400-1, 400-2 and 400-3 during the training computation.

The computational costs of the trained the neural network modules 400-1, 400-2 and 400-3, caused by the forward pass computations in (5b) and (5c) of Equation 5, may depend on the DNN structure parameters such as the number of layers and latent dimensions. Since the DNN inference involves linear matrix multiplications, which have cubic-order computational complexity with respect the system size, the objective space boundary identification according to at least one exemplary embodiment of the present disclosure is cost-efficient compared to existing iterative MOO solvers.

### Message Generation for Neural Network Modules

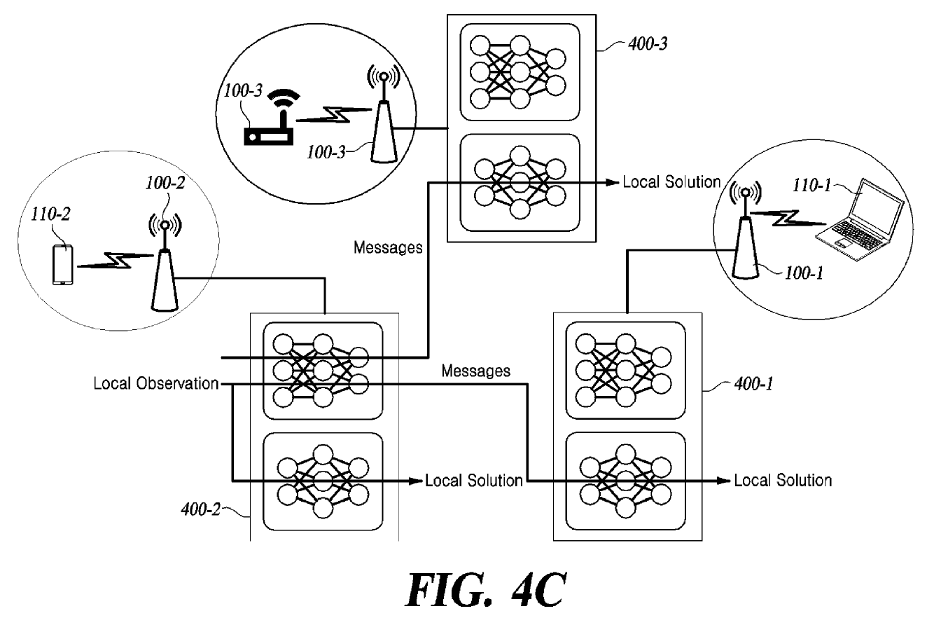

FIG. 5 illustrates training flow for messenger neural network according to at least one exemplary embodiment of the present disclosure.

The decentralized coordination is prone to the performance degradation resulting from insufficient message exchanges for the limited capacity of internode connections. Some exemplary embodiments of the present disclosure may provide a learning policy that includes the message quantization constraint in (7c) of Equation 7. Hereinafter, all subscripts are removed for simple presentation. It suffices to create an integer-valued message µ ∈ ℤ_{Q} = {0, 1, ..., Q - 1}.

The message quantization constraint is naturally imposed on instantaneous realizations of a and w. Therefore, it requires a novel training strategy distinct from the primal-dual learning algorithm, which is normally intended to handle average behaviors of the neural network modules. This invokes a sophisticated activation technique that encodes continuous-valued inputs of the messenger neural network 403, i.e., local observation and priority weight, into discrete messages. A major challenge lies in ensuring valid gradients of discrete DNN output required for the end-to-end back propagation to train. Simple quantization, such as binary activation, at DNN outputs exhibits gradient vanishing issues ending up with the training failure.

To remedy this, a stochastic quantization activation is developed such that it guarantees an integer output µ ∈ ℤ_{Q} for an arbitrary input value µ̃ ∈ [0,Q - 1]. This is a generalization of stochastic binarization activation applicable in case of Q = 2.

Provided that the DNN output µ̃ lies within the region [z - 1, z) for some integer , a random noise layer is added as an output activation that maps µ̃ to µ = z - 1 and µ = z randomly with probability z - µ̃ and 1 - (z - µ̃), respectively. As shown in FIG. 5, the mapping probabilities depend on the distances from continuous value q to adjacent integers z - 1 and z. To evaluate the gradient of the stochastic quantization activation for training, instead of instantaneous value of µ̃, quantized integer µ is used for evaluating the gradient in the backward pass computation, since µ is, in fact, an unbiased estimator of µ̃ and is known to act as its good approximation.

FIG. 5 also describes a hybrid computation structure for forward and backward passes of the messenger neural network. The sigmoid function is first applied to bound a continuous-valued message output within [0, Q-1]. The forward pass proceeds through the stochastic quantization activation, whereas the backward pass begins from the output of the bounding activation. As a consequence, the messenger neural network can be trained by avoiding the gradient vanishing problem to produce discrete message outputs, i.e., outgoing message, with continuous-valued local observation inputs. Finally, it is noted that the stochastic quantization activation is replaced with the uniform quantization activation, since the stochastic quantization is valid only when training the messenger neural network.

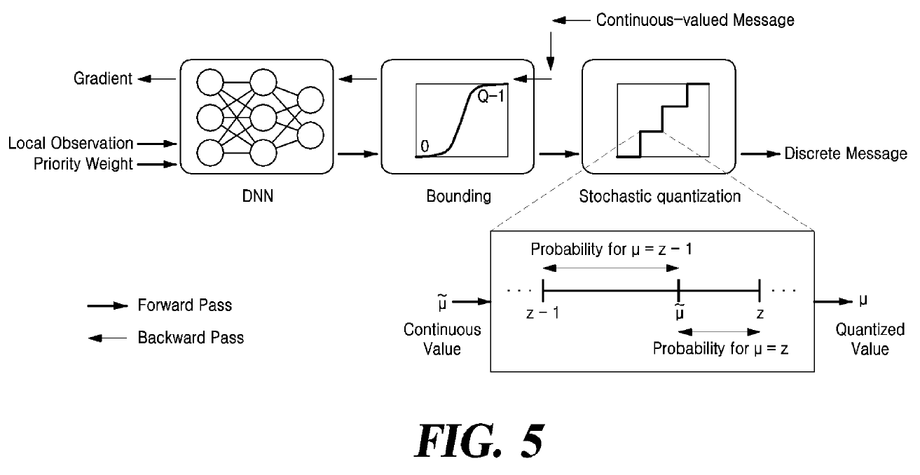

FIG. 6 is a flowchart illustrating a method for training one or more neural network modules according to at least one exemplary embodiment of the present disclosure.

The method shown in FIG. 6 may be performed by an electronic device (hereinafter, a training device) for training one or more neural network modules described above in FIGS. 1 to 5. The training device may be, for example, a programmable computer operated by a base station manufacturer.

The training device may acquire a training data set which includes one or more local observations and one or more priority weights (S600). For example, the training device may acquire the training data set from one or more base stations in which the one or more neural network modules 400-1, 400-2 and 400-3 will be installed, but is not limited thereto. For another example, the training device may generate the training data set based on a predetermined mathematical model.

The training device may calculate loss functions for training one or more neural network modules 400-1, 400-2 and 400-3, the objective neural network 420 and the dual neural network 430 (S610). Each loss function may be a function of trainable parameters including at least one of a messenger-optimizer parameter θ of one or more network modules 400-1, 400-2 and 400-3, an objective parameter φ of the objective neural network 420, and a dual parameter ψ of the dual neural network 430. The loss functions may include G(θ,ψ) in Equation 10, ℌ(φ, ψ) in Equation 10, and J(θ,φ,ψ) in Equation 13.

The training device may train one or more neural network modules 400-1, 400-2 and 400-3, which respectively include a messenger neural network 402 and an optimizer neural network 404, based on the training data set and an output of the dual neural network 430. The training device may train the optimizer neural network 404 to output a local solution, and may train the messenger neural network 402 to output a message for cooperation with other neural network modules. Each neural network module 400-1, 400-2 and 400-3 may be trained to calculate the local solution which maximizes a global objective under a constraint for a local objective of each neural network module 400-1, 400-2 and 400-3, a priority weight of each neural network module 400-1, 400-2 and 400-3 and the global objective. For example, the neural network module 400-1 module may be trained to calculate the local solution for the neural network module 400-1 which maximizes the global objective under a constraint for a local objective of the neural network module 400-1, the priority weight of the neural network module 400-1 and the global objective. Each neural network module 400-1, 400-2 and 400-3 may be trained to convert the local observation of each neural network module 400-1, 400-2 and 400-3 and the priority weight of each neural network module 400-1, 400-2 and 400-3 into the message having quantized value. For example, the neural network module 400-1 may be trained to convert the local observation of the neural network module 400-1 and the priority weight of the neural network module 400-1 into the message having quantized value for cooperation with the neural network module 400-2 and/or the neural network module 400-3.

Herein, training of the neural network modules 400-1, 400-2 and 400-3 may be referred to as, for example, training of a parameter of the neural network modules 400-1, 400-2 and 400-3, updating of the neural network modules 400-1, 400-2 and 400-3, and updating of the parameter of the neural network modules 400-1, 400-2 and 400-3. The training device may calculate a gradient of the loss function G(θ,ψ) for the messenger-optimizer parameter θ, and may update the messenger-optimizer parameter θ based on the calculated gradient. The messenger-optimizer parameter θ of the neural network modules 400-1, 400-2 and 400-3 may be updated to maximize the loss function G(θ,ψ).

The training device may train the objective neural network 420 to output the global objective of one or more neural network modules 400-1, 400-2 and 400-3 based on the priority weights and the output of the dual neural network 430 (S620).

Herein, training of the objective neural network 420 may be referred to as, for example, training of a parameter of the objective neural network 420, updating of the objective neural network 420, and updating of the parameter of the objective neural network 420. The training device may calculate a gradient of the loss function ℌ(φ,ψ) for the objective parameter φ, and may update the objective parameter φ based on the calculated gradient. The objective parameter φ of the objective neural network 420 may be updated to increase the loss function ℌ(φ,ψ) , which is, in fact, the weighted average of global objectives F_{φ}(w) with respect to various directions of a priority vector w.

The training device may train the dual neural network 430 to output a dual variable for primal-dual optimization based on the priority weights and an output of the objective neural network 420 (S630).

Herein, training of the dual neural network 430 may be referred to as, for example, training of a parameter of the dual neural network 430, updating of the dual neural network 430, and updating of the parameter of the dual neural network 430. The training device may calculate a gradient of the loss function J(θ,φ,ψ) for the dual parameter ψ, and may update the dual parameter ψ based on the calculated gradient. The dual parameter ψ of the dual neural network 430 may be updated to minimize the loss function J(θ,φ,ψ). The output of dual neural network 430 may be a nonnegative value.

The training device may determine whether the neural network modules 400-1, 400-2 and 400-3 have achieved the target performance (S650). In some exemplary embodiments, achieving the target performance may include that the local objective of each neural network module 400-1, 400-2 and 400-3 reaches a predetermined threshold, or that the number of repetitions of the training process reaches a predetermined threshold, but is not limited thereto.

The training device may alternate the training of the neural network modules 400-1, 400-2 and 400-3, the objective neural network 420, and the dual neural network 430 until the neural network modules 400-1, 400-2 and 400-3 have achieved the target performance (S610 to S650).

In some exemplary embodiments, the neural network modules 400-1, 400-2 and 400-3 may be distributed to each base station 100-1, 100-2 and 100-3 after training of the neural network modules 400-1, 400-2 and 400-3 is completed.

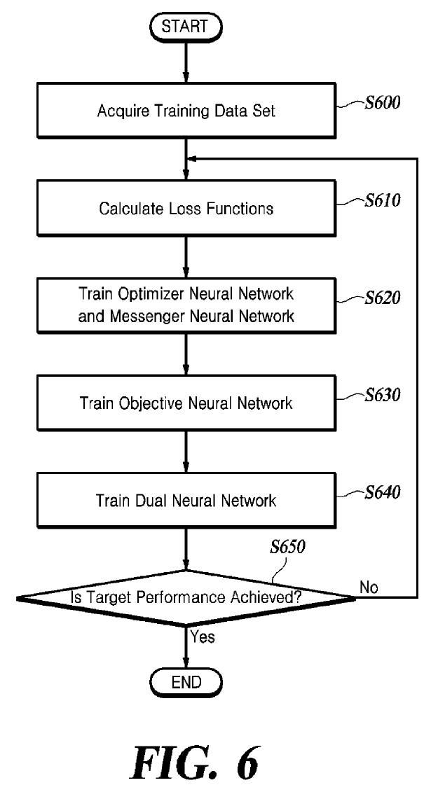

FIG. 7 is a flowchart illustrating a method for computing a local solution of a multi-objective optimization problem according to at least one exemplary embodiment of the present disclosure.

The method shown in FIG. 7 may be performed by the neural network module described above in FIGS. 1 to 5, or an electronic device (hereinafter, a computing device) having the neural network module, and hence reiterating details thereof will be omitted.

The computing device may acquire a local observation (S700). The computing device may acquire the local observation in real-time from a terminal. For example, the computing device may receive channel state information (CSI), as the local observation, from the terminal.

The computing device may generate a first message for cooperation with at least one counterpart computing device based on a local observation and a priority weight, and may transmit the first message to the counterpart computing device (S710). The computing device may obtain the first message by inputting the local observation and the priority weight to a pre-trained messenger neural network 402. The messenger neural network 402 may be pre-trained to convert the local observation and the priority weight into the first message having a quantized value. To this end, the computing device may obtain the priority weight from the terminal. When the computing device is implemented as a base station, the counterpart computing device may be another base station interconnected with the base station via a backhaul link.

The computing device may receive a second message from the counterpart computing device (S720).

The computing device may calculate a local solution for the computing device based on the local observation, the priority weight, and the second message (S730). The computing device may obtain the local solution by inputting the local observation, the priority weight, and the second message to a pre-trained optimizer neural network 404. The optimizer neural network 404 may be pre-trained to calculate the local solution which maximizes a global objective of the computing device and the counterpart computing device under a constraint for a local objective of the computing device, the priority weight, and the global objective.

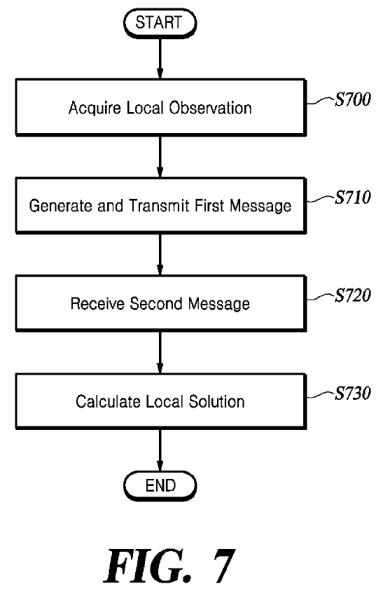

FIG. 8 is a block diagram illustrating a device for training one or more neural network modules according to at least one exemplary embodiment of the present disclosure.

A training device 80 may include all or some of a transceiver 800, a memory 802 and a processor 804. The training device 80 may be an electronic device for training one or more neural network modules. For example, the training device 80 may be a programmable computer operated by a base station manufacturer, but is not limited thereto.

The transceiver 800 may be connected to the processor to communicate with a computing device, e.g., a base station. The transceiver 800 may include, for example, all or some of a transmission filter, a reception filter, an amplifier, a mixer, an oscillator, a Digital-to-Analog Convertor (DAC), an Analog-to-Digital Convertor (ADC), and the like.

The memory 802 may be connected to the processor 804 to store various pieces of information for driving the processor 804. The memory 802 may store at least one instruction executed by the processor 804. The memory may include at least one of a volatile memory and a nonvolatile memory. The volatile memory may include at least one of a Static Random Access Memory (SRAM), a Dynamic Random Access Memory (DRAM), and the like. The nonvolatile memory may include flash memory and the like.

The processor 804 may control overall functions for controlling the training device 80. For example, the processor 804 may take overall control of the training device 80 by executing programs stored in the memory 802 in the training device 80.

The processor 804 may control the transceiver 800 to communicate with a computing device, and may control the memory 802 to store a received signal or to store a signal to be transmitted.

The processor 804 may be configured to implement the functions, procedures and/or methods described above in FIGS. 1 to 7. In some embodiments described above, the functions, procedures and/or methods for training one or more neural network modules may be implemented by processor 804.

For example, the processor 804 may be configured to acquire a training data set which includes one or more local observations and one or more priority weights, to train the dual neural network to output a dual variable for primal-dual optimization based on the priority weights and an output of the objective neural network, to train the objective neural network to output a global objective of the neural network modules based on the priority weights and an output of the dual neural network, to train neural network modules to output a message for cooperation with each other and a local solution based on the training data set and the output of the dual neural network.

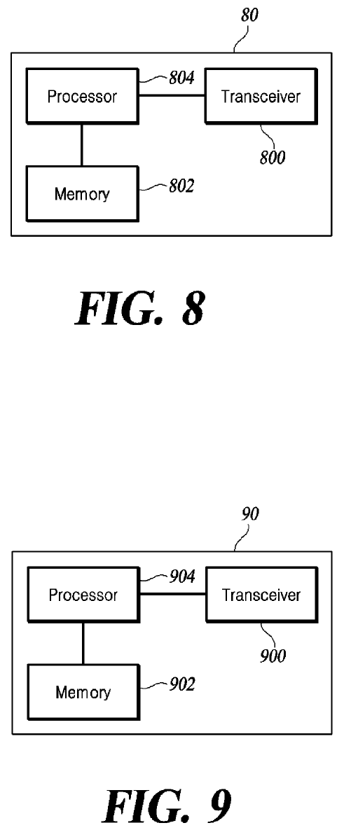

FIG. 9 is a block diagram illustrating a device for computing a local solution of a multi-objective optimization problem according to at least one exemplary embodiment of the present disclosure.

A computing device 90 may include all or some of a transceiver 900, a memory 902 and a processor 904. The computing device 90 may be an electronic device for distributed computation of a local solution of a multi-objective optimization problem. For example, the computing device 90 may be a base station existent in the distributed network, but is not limited thereto.

The transceiver 900 may be connected to the processor to communicate with a terminal, other computing devices 90, and/or a training device 80. The transceiver 900 may include, for example, all or some of a transmission filter, a reception filter, an amplifier, a mixer, an oscillator, a Digital-to-Analog Convertor (DAC), an Analog-to-Digital Convertor (ADC), and the like.

The memory 902 may be connected to the processor 904 to store various pieces of information for driving the processor 904. The memory 902 may store at least one instruction executed by the processor 904. The memory may include at least one of a volatile memory and a nonvolatile memory. The volatile memory may include at least one of a Static Random Access Memory (SRAM), a Dynamic Random Access Memory (DRAM), and the like. The nonvolatile memory may include flash memory and the like. The memory 902 may store a neural network module including a messenger neural network, which is pre-trained to generate a message for cooperation with one or more other nodes, and an optimizer neural network, which is pre-trained to calculate a local solution in an individual node.

The processor 904 may control overall functions for controlling the computing device 90. For example, the processor 904 may take overall control of the computing device 90 by executing programs stored in the memory 902 in the computing device 90.

The processor 904 may control the transceiver 900 to communicate with a terminal, another computing device 90, and/or a training device 80. The processor 904 may control the memory 902 to store a received signal or to store a signal to be transmitted.

The processor 904 may be configured to implement the functions, procedures and/or methods described above in FIGS. 1 to 7. In some embodiments described above, the operation of the node or computing device may be implemented by processor 904.

For example, the processor 904 may be configured to generate a first message for cooperation with at least one counterpart computing device based on a local observation and a priority weight, to transmit the first message to the counterpart computing device, receive a second message from the counterpart computing device, to calculate a local solution for the computing device based on the local observation, the priority weight, and the second message.

Although FIGS. 6 to 7 presents the respective steps thereof as being sequentially performed, it merely instantiates the technical idea of some embodiments of the present disclosure. Therefore, a person having ordinary skill in the pertinent art could incorporate various modifications, additions, and substitutions in practicing the present disclosure by changing the sequence of steps illustrated by FIGS. 6 to 7 or by performing one or more of the steps thereof in parallel, and hence the steps in FIGS. 6 to 7 are not limited to the illustrated chronological sequences.

Various implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. Computer programs, which are also known as programs, software, software applications, or codes, contain instructions for a programmable processor and are stored in a “computer-readable recording medium.”

The computer-readable recording medium includes any types of recording device on which data that can be read by a computer system are recordable. Examples of computer-readable recording medium include non-volatile or non-transitory media such as a ROM, CD-ROM, magnetic tape, floppy disk, memory card, hard disk, optical/magnetic disk, storage devices, and the like. The computer-readable recording medium further includes transitory media such as data transmission medium. Further, the computer-readable recording medium can be distributed in computer systems connected via a network, wherein the computer-readable codes can be stored and executed in a distributed mode.

Various implementations of the systems and techniques described herein can be realized by a programmable computer. Here, the computer includes a programmable processor, a data storage system (including volatile memory, nonvolatile memory, or any other type of storage system or a combination thereof), and at least one communication interface. For example, the programmable computer may be one of a server, a network device, a set-top box, an embedded device, a computer expansion module, a personal computer, a laptop, a personal data assistant (PDA), a cloud computing system, and a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. A method, performed by a computing device, for computing a local solution of a multi-objective optimization problem, the method comprising:
generating a first message for cooperation with at least one counterpart computing device based on a local observation and a priority weight;
transmitting the first message to the counterpart computing device;
receiving a second message from the counterpart computing device; and
calculating the local solution for the computing device based on the local observation, the priority weight, and the second message.

2. The method of claim 1, wherein the generating the first message comprises:
obtaining the first message by inputting the local observation and the priority weight to a messenger neural network.

3. The method of claim 2, wherein the messenger neural network is pre-trained to convert the local observation and the priority weight into the first message having a quantized value.

4. The method of claim 1, wherein the calculating the local solution comprises:
obtaining the local solution by inputting the local observation, the priority weight, and the second message to an optimizer neural network.

5. The method of claim 4, wherein the optimizer neural network is pre-trained to calculate the local solution which maximizes a global objective of the computing device and the counterpart computing device under a constraint for a local objective of the computing device, the priority weight, and the global objective.

6. The method of claim 1, further comprising:
acquiring at least one of the local observation and the priority weight from one or more terminals.

7. A method, performed by a training device, for training one or more neural network modules by using an objective neural network and a dual neural network, the method comprising:
acquiring a training data set which includes one or more local observations and one or more priority weights;
training the dual neural network to output a dual variable for primal-dual optimization based on the priority weights and an output of the objective neural network;
training the objective neural network to output a global objective of the neural network modules based on the priority weights and an output of the dual neural network; and
training neural network modules to output a message for cooperation with each other and a local solution based on the training data set and the output of the dual neural network.

8. The method of claim 7, wherein the training the neural network modules comprises:
calculating a first gradient of a first loss function for a first parameter of the neural network modules; and
updating the first parameter based on the first gradient,
wherein each neural network module is trained to calculate the local solution which maximizes the global objective under a constraint for a local objective of each neural network module, a priority weight of each neural network module, and the global objective.

9. The method of claim 8, wherein the first loss function is calculated based on:
$$G \left(θ , ψ\right) ≜ {\sum }_{w ∈ W} {N}_{ψ} {\left(\text{w}\right)}^{T} \tilde{\text{f}} \left(θ , \text{w}\right)$$
where G(θ, ψ) is the first loss function, θ is the first parameter, ψ is a parameter of the dual neural network, w is a priority vector which is a set of the priority weights, N_{ψ}(w) is the output of the dual neural network, and f̃(θ,w) is a set of an average local objective of each neural network module.

10. The method of claim 7, wherein each neural network module is trained to convert the local observation of each neural network module and the priority weight of each neural network module into the message having quantized value.

11. The method of claim 7, wherein the training the objective neural network comprises:
calculating a second gradient of a second loss function for a second parameter of the objective neural network; and
updating the second parameter based on the second gradient,
wherein the second loss function is a weighted average of the global objective.

12. The method of claim 11, wherein the second loss function is calculated based on:
$$H \left(φ , ψ\right) ≜ {\sum }_{\text{w} ∈ W} \left(\frac{1}{\left|W\right|} - {N}_{ψ} {\left(w\right)}^{T} \text{w}\right) ⋅ {F}_{φ} \left(\text{w}\right)$$
where
$$H ( φ , ψ )$$
is the second loss function, w is a priority vector which is a set of the priority weights, N_{ψ}(w) is the output of the dual neural network, F_{φ}(w) is the output of the objective neural network, and |W| is the number of all priority weight candidates.

13. The method of claim 7, wherein the training the dual neural network comprises:
calculating a third gradient of a third loss function for a third parameter of the dual neural network; and
updating the third parameter based on the third gradient,
wherein the output of the dual neural network is a nonnegative value.

14. The method of claim 13, wherein the third loss function is calculated based on:
$$J \left(θ , φ , ψ\right) ≜ {\sum }_{\text{w} ∈ W} {N}_{ψ} {\left(\text{w}\right)}^{T} \left(\tilde{\text{f}} \left(θ , \text{w}\right) - \text{w} ⋅ {F}_{φ} \left(\text{w}\right)\right)$$
where J(θ, φ, ψ) is the third loss function, N_{ψ}(w) is the output of the dual neural network,
$$\tilde{\text{f}} \text{(θ,w)}$$
is a set of an average local objective of each neural network module, w is a priority vector which is a set of the priority weights, and F_{φ}(w) is the output of the objective neural network.

15. A computing device for computing a local solution of a multi-objective optimization problem, the device comprising:
a processor; and
a non-transitory memory storing at least one instruction executed by the processor,
wherein the processor is configured to:
generate a first message for cooperation with at least one counterpart computing device based on a local observation and a priority weight;
transmit the first message to the counterpart computing device;
receive a second message from the counterpart computing device; and
calculate a local solution for the computing device based on the local observation, the priority weight, and the second message.

16. A training device for training one or more neural network modules by using an objective neural network and a dual neural network, the training device comprising:
a processor; and
a non-transitory memory storing at least one instruction executed by the processor,
wherein the processor is configured to:
acquire a training data set which includes one or more local observations and one or more priority weights;
train the dual neural network to output a dual variable for primal-dual optimization based on the priority weights and an output of the objective neural network;
train the objective neural network to output a global objective of the neural network modules based on the priority weights and an output of the dual neural network; and
train neural network modules to output a message for cooperation with each other and a local solution based on the training data set and the output of the dual neural network.

17. A computer program stored in a computer-readable medium for executing the steps respectively included in the method according to claim 1.

18. A computer program stored in a computer-readable medium for executing the steps respectively included in the method according to claim 7.
